(19) United States
(12) Patent Application Publication
(10) Pub. No.: US 2010/0013910 A1
(43) Pub. Date: Jan. 21, 2010

(54) STEREO VIEWER

(75) Inventor: Mina Farr, Palo Alto, CA (US)

Correspondence Address: Workman Nydegger;1000 Eagle Gate Tower, 60 East South Temple, Salt Lake City, UT, 84111, US

(73) Assignee: VIVID MEDICAL, San Jose, CA (US)

(21) Appl. No.: 12/502,942

(22) Filed: Jul. 14, 2009

Related U.S. Application Data
(60) Provisional application No. 61/082,432, filed on Jul. 21, 2008.

(51) Int. Cl. H04N 13/04; G02B 27/22; G06F 3/041; G10L 15/00

(52) U.S. Cl. 348/51; 359/471; 345/173; 704/246; 348/E13.075; 704/E15.001

(57) ABSTRACT

Various embodiments of opto-electronic display modules for viewing real time, stored or computer generated images and video information in 3D or 2D are presented. The various 2D or 3D viewer embodiments of the present disclosure allow independent use of the imaging information in a way that is convenient to the user without affecting the other tasks that the user needs to perform. Multiple viewers of the present embodiment can be used concurrently by multiple users, where each viewer is fully maneuverable and controllable for and by each specific user. Additionally, the viewer of the present disclosure may communicate to various input devices as well as send user commands to such devices in an electrical, optical, or wireless transmission format.

### CROSS-REFERENCE TO RELATED APPLICATIONS

This application claims the benefit of and priority to U.S. Provisional Patent Application No. 61/082,432 filed Jul. 21, 2008, and entitled “Individual Stereo Viewer,” the disclosure of which is incorporated herein by reference in its entirety.

### BACKGROUND

1. The Technical Field

The present disclosure relates generally to apparatus for electronic stereo viewing of medical and pathological images. Binocular electronic stereo images can be captured using stereo endoscopes in variety of endoscopic surgical applications using 3-dimensional (3D) medical imaging equipment, as well as in pathology examination of specimens in 3D under stereo microscope equipment with dual electronic image capture devices. The present disclosure describes an apparatus for viewing of such stereo images.

2. Related Technology

Endoscopes of a variety of forms are used both in both diagnostic and surgical procedures. Currently, minimally invasive surgery (MIS) procedures, as opposed to open surgical procedures, are routinely done in almost all hospitals. Minimally invasive techniques minimize trauma to the patient by eliminating the need to make large incisions. This both reduces the risk of infection and reduces the patient's hospital stay. Laparoscopic and endoscopic procedures in MIS use different types of endoscopes as imaging means, giving the surgeon an inside-the-body view of the surgical site. Specialized endoscopes are named depending on where they are intended to look. Examples include cystoscopes (bladder), nephroscopes (kidney), bronchoscopes (bronchi), laryngoscopes (larynx/the voice box), otoscopes (ear), arthroscopes (joint), laparoscopes (abdomen), gastrointestinal endoscopes, and specialized stereo endoscopes used as laparoscopes or for endoscopic cardiac surgery.

The endoscope may be inserted through a tiny surgical incision to view joints or organs in the chest or abdominal cavity. More often, the endoscope is inserted into a natural body orifice such as the nose, mouth, anus, bladder, or vagina. There are three basic types of endoscopes: rigid, semi-rigid, and flexible. The rigid endoscope comes in a variety of diameters and lengths depending on the requirements of the procedure.

A stereo vision system is an invaluable solution when implemented in endoscopy. It improves surgeon's dexterity, accuracy, and reduces time of operation by providing a complete magnified view of the area similar to a stereo microscope visualization. A variety of endoscopes, such as cystoscopes, nephroscopes, bronchoscopes, laryngoscopes, otoscopes, arthroscopes, laparoscopes, and flexible gastrointestinal endoscopes, may be made to incorporate means for stereo vision capture.

Stereo microscopes used in pathology labs also allow 3D views of pathology samples. Stereo microscopes are also an invaluable tool in micro surgical applications such as in brain surgery. 3D and binocular models of the body may be computer generated in 3D by processing medical imaging system data such as in MRI, CAT scan, X-ray, and Ultrasound.

Viewing of 3D stereo information in real time by a surgeon helps achieve better procedure outcome. However, current stereo viewing in surgical environment is limited to large stereo consoles using dual display systems, or head mounted displays that must be worn in a fixed fashion on the head.

Large 3D stereo viewers limit the use of the stereo viewer to a position near or at a remote surgical site, where the surgery is performed by tele-robotic arms. In this type of system the surgeon relies on the medical staff next to the patient to perform other surgical operation tasks and have the support staff inform the surgeon as to various other task outcomes.

The head-mounted solution, such as in eye-glass or goggle type 3D stereo displays fixed on the surgeon's head, are disorienting to the surgeon. These displays move as the surgeon moves his or her head while the view of the operating site is fixed with respect to the user's point of view. The head mounted display solutions also limit the visual field of the surgical staff. These type displays rely on very compact projection type optics that have limited projection field for the positioning of the user's eye pupil to achieve very large projected images. This limits how far away the goggle or head mount displays can be with respect to a user's eye. Partial views of the actual surgical site, either by making the displays partially transparent, or by limiting the area of the eye the display covers, are not acceptable. Head mount displays are also cumbersome to remove and/or re-position for optimal viewing.

### BRIEF SUMMARY

These and other limitations may be overcome by embodiments of the disclosure which relate to small, high resolution 2-dimensional (2D) or 3D stereo viewers that are fully maneuverable in the surgical environment and can be positioned above the patient without any physical attachment to the user's head. The present 3D stereo viewer may be conveniently adjusted to a fixed location in space for optional viewing of the 3D information, where the surgeon may move their head and direct their line of sight easily to the patient and the 3D viewer at any time.

The 3D viewer of the present disclosure may have a cut out portion or a free space opening, at the front bottom portion of the 3D viewer. The 3D stereo viewer may be set at a comfortable distance from the user's head, where the user can easily gain a lower line of site to the area of observation simply by looking down. Also, by having a relatively larger distance from the user's eyes and the physical space that the user can comfortably gain 3D viewing, the surgeon may be free to lower or tilt his or her head for optimum viewing of the actual surgical site. The user may also be free to move their head farther away from the 3D viewer and to the sides to perform other surgical tasks.

The current embodiment of 3D stereo visualization gives adequate field of view for stereo viewing of the surgical site. To achieve the feeling of immersion, the surgeon can optionally position their head closer to the 3D monitor by resting their head on the forehead rest mechanism for example.

Mixed media stereo images may be viewed independently or as overlaid 3D images on the stereo viewer. These stereo images could be from real time stereo viewing devices such as a stereo endoscope, or a stereo microscope equipped with dual image capture devices, or a computer generated binocular 3D image from a CT scan, MRI, ultrasound, or other similar medical imaging devices.

### BRIEF DESCRIPTION OF THE DRAWINGS

To further clarify the features of the present disclosure, a more particular description of the disclosure will be rendered by reference to specific embodiments thereof which are illustrated in the appended drawings. It is appreciated that these drawings depict only typical embodiments of the disclosure and are therefore not to be considered limiting of its scope. Embodiments of the disclosure will be described and explained with additional specificity and detail through the use of the accompanying drawings in which:

FIG. 1 illustrates an example compact 3D stereo viewer as observed by a user at a comfortable distance from the user.

FIG. 2 illustrates the stereo viewer of FIG. 1, providing illumination to the surgical site, as the user looks down on the surgical site.

FIG. 3 illustrates an example design of such compact 3D viewer depicted in FIG. 1.

FIG. 4 illustrates the binocular convergence of the 3D viewer design of FIG. 2, at a comfortable nominal viewing distance resembling the actual object position with reference to the user's eye.

FIG. 5 illustrates the stereo viewer of FIG. 1, further equipped with a maneuvering handle, and input devices such as a touch pad, joystick, and electronic buttons.

FIG. 6 illustrates the 3D viewer of FIG. 5 mounted on a fully adjustable, overhead mounting mechanism that allows position of the viewer anywhere above the operating table.

FIG. 7 illustrates multiple 3D stereo viewers used concurrently at multiple positions in an operating room.

FIG. 8 illustrates an example fully adjustable and maneuverable floor holding mechanism for the 3D stereo viewer, which also accommodates electrical or optical cable connections to the 3D stereo viewer on the holding mechanism.

FIG. 9 illustrates an example wireless connection associated with the 3D stereo viewer that can transmit image data and commands to and from a stereo endoscope, a remote or local computer, a storage device, or other displays.

FIG. 10 illustrates a single display used in Stereo viewing, by simultaneously displaying the right and left stereo images on the two halves of the single display.

FIG. 11 illustrates an example single display being viewed in stereo, with alternating right and left stereo images being displayed by the single display.

FIG. 12 illustrates a further example optical design for a 3D stereo viewer with less depth dimension and a single reflector in front of each eye.

FIG. 13 represents schematics of a projection type optics that can be used in the 3D stereo viewer using micro displays instead of flat panel displays.

### DETAILED DESCRIPTION OF THE EXAMPLE EMBODIMENTS

Embodiments of the current disclosure are directed to general individual display units that can enable 3D stereo viewing of medical stereoscopic or binocular images. 3D stereo images can be captured using stereo endoscopes in a variety of forms, such as rigid, semi-rigid, and flexible, endoscopes with any fields of view (FOV), as well as angled endoscopes with various directions of view.

Stereo images captured during stereo digital microscopy or stereo micro surgery, representing 3D tissue structure or organ inside the body or on the skin, can be viewed in real time using the 3D stereo viewer. Past 3D imaging information obtained in similar manner or reconstructed from various other medical imaging mechanisms such as MRI, Ultrasound, CT scan, etc., may also be played on the stereo viewer at the same time as the real time video images.

The stereo images whether taken in the visual spectrum of light or in Infrared or UV imaging, or as a result of bio fluorescence spectral imaging, convey a lot of information when superimposed with the real time visual stereo image data. Different modality imaging data can be processed and matched in position and magnification using image capture markers to the real time stereo image data, and viewed in stereo by or fed as a 2D image to only one eye of the stereo viewer.

Human stereo vision inherently renders higher level of resolution due to a human brain's processing capability of stereo images, referred to as Stereo Visual Summation. Thus, human perception of image resolution, definition, and contrast are all improved in stereo viewing. Also, any extra information presented to a single eye can be viewed comfortably and without confusion, in the stereo viewer without lack of perspective or affecting the stereo 3D vision.

Mixing of multi-modal stereo image data allows different type of information from a variety of imaging and tissue analysis sources that reveal the soft tissue, bones, and muscular structure, as well as tissue structure, to be readily observed, recognized, and manipulated with observation in the stereo viewer. The stereo viewer can simultaneously display matched 3D stereo images, or mix 2D images matched to one of the stereo images (left or right eye).

It is desirable to have a versatile viewing apparatus that can be easily implemented in surgical settings, medical settings, and lab environment. With today's high tech medical environment using a variety of imaging and display systems, the surgical area is crowded with various medical equipment and multimedia displays used around the patient. This not only limits the medical staff from easily accessing all the equipment, it also requires multiple people around the patient to perform only few tasks at a time.

The electronic rack mounted or wall and ceiling mounted video displays in the operating room are large and cumbersome to adjust for optimal viewing, and seldom offer a complete view for all the staff at different locations in the room. Glare from surgical lights in the room is also not controlled in all positions, thus sometimes a user positioned at a specific position is unable to see the display well. The surgical staff also does not have access to the same exact view as the main surgeon. This raises the learning curve and limits the coordination of the various surgeons concurrently participating in the operation.

Human hand-eye coordination is improved with use of instruments in the usual postures that one is inherently trained on. For example the surgeon is used to operate on a patient standing next to the bed. Long surgical procedures also dictate an ergonomic access and use of medical equipment and instruments, without strain to the body, neck or the human visual system. Thus, a fully adjustable personal display for each member of the surgical staff is highly desirable.

Having a magnified 2D or 3D view of the surgical site directly above the patient, at the eye level of the doctor, is a convenient and ergonomic way for the surgeon to view the information. Since access to the space is limited directly above the patient, and one cannot obscure the general surgical lighting system directly above the patient, a drop down small viewer with added illumination in the bottom to illuminate the surgical area is highly desirable in providing the desired task lighting.

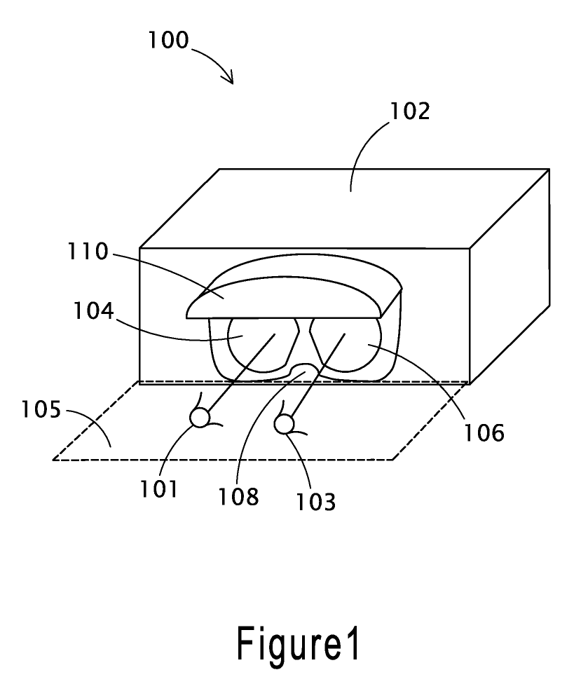

FIG. 1 represents an example compact 3D stereo viewer 100 in accordance with the current disclosure, where the viewer body 102 provides dual large visual access ports 104 and 106 for the left eye 101, and right eye 103 of the user, as they look directly inside the access ports 104 and 106. The compact 3D stereo viewer 100 has an open area in the bottom front portion of the viewer represented as 105 in FIG. 1. This open area 105 can be used to look down and gain view of the surgical site or the user's hands performing a task. The viewing distance provided above this open area 105, in front of the 3D stereo display, is such that it can also allow the user to easily use their personal visual aids such as prescription glass while using the stereo display. This means the user can use their prescription glasses to view the viewer as well as the workplace below seamlessly.

Front panel of the 3D stereo viewer is also equipped with features to ease head positioning and possibly facilitate contact with the user's head. A rounded feature and surface relief structure 108 in the middle of the display just below and/or between the left and right eye visual access ports 104 and 106 can make accommodations for the user's nose. An arc-shaped forehead support 110 protruding out from the visual access ports 104 and 106 can be used to accommodate a contact point to the user's forehead. In a further embodiment, the forehead support 110 can additionally provide a comfortable forehead resting surface with soft disposable padding on the forehead support 110 that can wick the sweat off of the user's forehead.

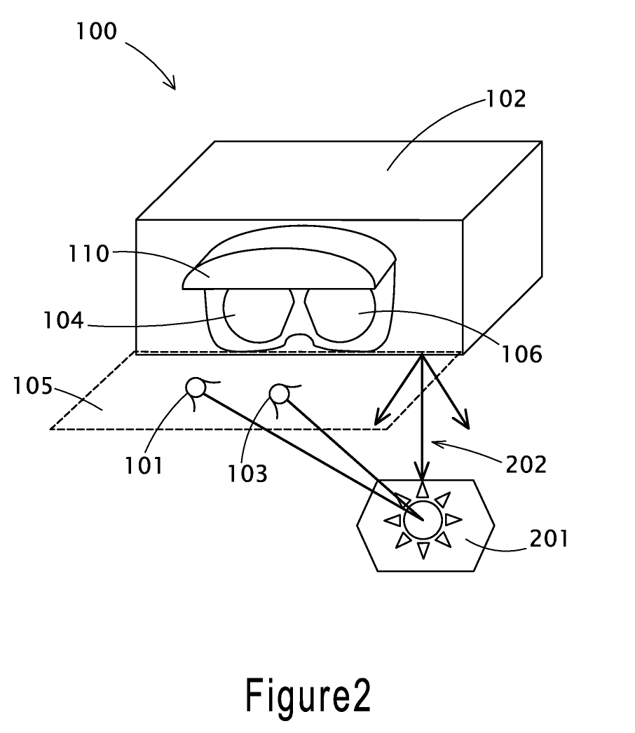

FIG. 2 represents the user's eyes 201 and 203 in the down position with respect to the viewer 100, looking at the surgical or work area 201 through the open space 105. Possible solid state lighting can be incorporated on the bottom surface of the viewer 100, which can be used for illuminating the surgical or work area 201 through down lighting 202.

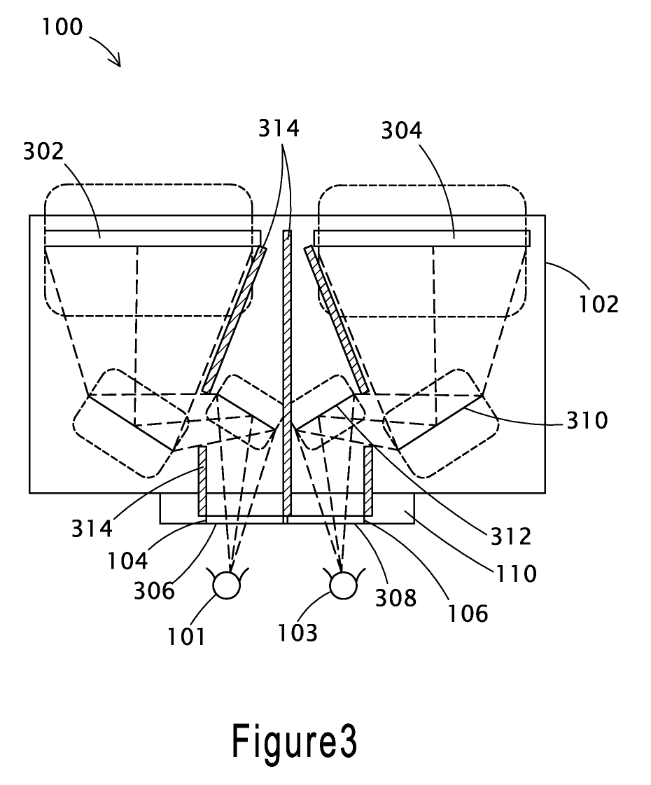

FIG. 3 represents an embodiment of the internal optical design structure for the 3D stereo viewer 100, where 3D viewer body 102 houses dual flat panel displays 302 and 304, such as small high resolution LCDs for stereo viewing. Multiple fold mirror mechanisms, such as mirrors 310 and 312, can guide the images through an optical path from the displays 302 and 304 to the visual access ports 104 and 106. Visual access ports 104 and 106 may include flat optical windows 306 and 308, or alternatively lenses with optical power to provide certain magnification of the images, or to serve as visual aid for user. Coating and curvature on the surfaces of the windows 306 and 308 can help reduce any possible glare and reflection from the window to reach the user's eye. Optical windows with optical power can be made removable or adjustable in optical power based on the user's choice and visual needs.

To avoid light leakage from either side of the stereo viewer 100, and to prevent glare as well as avoid direct view of the displays without traversing the designed optical fold or projection path, optical baffle mechanisms 314 can be implemented inside the viewer. The inside surface of the viewer body 102 and all the surfaces of the optical baffle mechanisms, as well as any unused surfaces of the mirrors 310 and 312 and all other mechanisms inside the housing 102, such as mounting mechanisms, can be coated or painted with anti-reflective, light-absorbing black material.

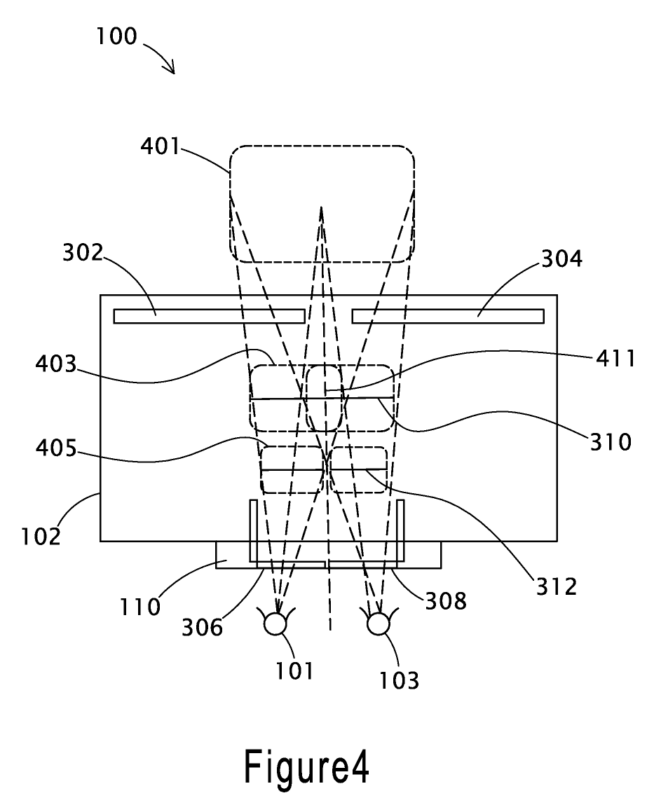

FIG. 4 represents an example unfolded optical path of the 3D stereo viewer 100, having intermediate images 403 and 405 at the fold mirror positions 310 and 312 of the stereo image 401. The intermediate images 403 and 405 traverse the unfolded optical path as they converge to the stereo image 401, at a convenient visual convergence distance 411 from the user's eyes 101 and 103. The convergence distance 411 of the 3D stereo viewer 100 can be set to replicate a distance similar to the working distance of the operational site to the user's eye position. This can allow the user to work both with the 3D stereo viewer 100 and perform other tasks with direct view without any change in the user's visual system, thereby preventing eye strain. In one embodiment, the visual convergence distance 411 of the 3D stereo viewer 100 can be set at about 1 to 2 feet from the user's eye, which is the usual working distance for task intensive visualization.

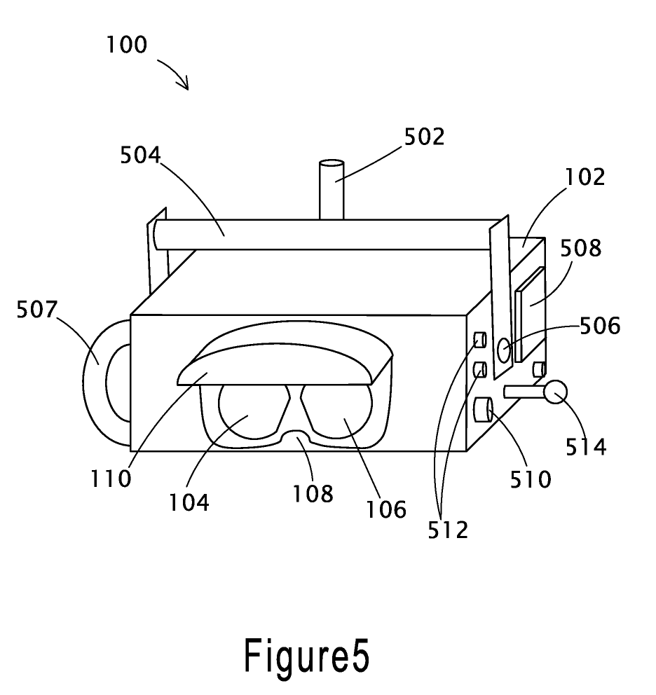

As represented in FIG. 5, the 3D stereo viewer 100 may include one or more mounting mechanisms, such as a rotatable support member 504 and a vertical support member 502 coupled to the rotatable support member 504. The rotatable support member 504 and vertical support member 502 may facilitate mounting of the 3D stereo viewer 100 from above. The rotatable support member 504 may include and/or be operatively associated with a locking mechanism, such as a moveable and lockable hinge 506 to allow adjustment of the direction of view in the up and down direction. The rotatable support member 504 and vertical support member 502 may also allow for rotation of the 3D stereo viewer 100 relative to the rotatable support member 504 and vertical support member 502. Such rotational adjustment in the direction of view can allow for comfortable viewing angles to be set by the user. The compact 3D stereo viewer 100 may also include a handle 507 on the viewer body 102, which a user can use to manually manipulate the rotational direction of the compact 3D stereo viewer 100.

Various interactive user interfaces can also be implemented into the compact 3D stereo viewer 100, such as into the viewer body 102, to control the compact 3D stereo viewer 100 and send commands to various other equipment that are communicatively connected to the compact 3D stereo viewer 100. For instance, the compact 3D stereo viewer 100 may include a computer input type touch pad 508, finger mouse 510, and/or electronic control buttons 512 mounted on the side of the viewer body 102 and configured to execute and/or transmit a user's commands to the 3D stereo viewer 100 and/or outside the 3D stereo viewer 100. In a further embodiment, the 3D stereo viewer 100 may be configured to operate in accordance with voice activation by incorporating a voice recognition mechanism inside the 3D stereo viewer 100, where the user's voice commands are recognized and executed by the voice recognition mechanism.

The 3D stereo viewer 100 can also include a microprocessor configured to perform certain computational functions and process information such as image decompression and processing. In addition, the 3D stereo viewer 100 may include a power source, such as a battery that can be removed, exchanged, and/or otherwise recharged after each use.

The 3D stereo viewer 100 may also include a multi functional computer game type joystick 514, which can be mounted on the viewer body 102. The joystick 514 may be configured to adjust the spacial position of the 3D stereo viewer in the operating room. In a further embodiment, the joystick 514 may be configured to adjust the rotational direction of 3D stereo viewer 100, such as by rotating the joystick 514.

Icons of various image media available to the viewer such as X-ray, Ultrasound, MRI, and the like can be displayed on one or both eye images in the 3D display. The touch pad 508 or the finger mouse 510 can be used to move the mouse icon to the various image media icons, where an imaging choice can be set and the 3D stereo viewer 100 can visualize the information on one side or as stereo overlays to the 3D live stereo video signal from a stereo endoscope or microscope.

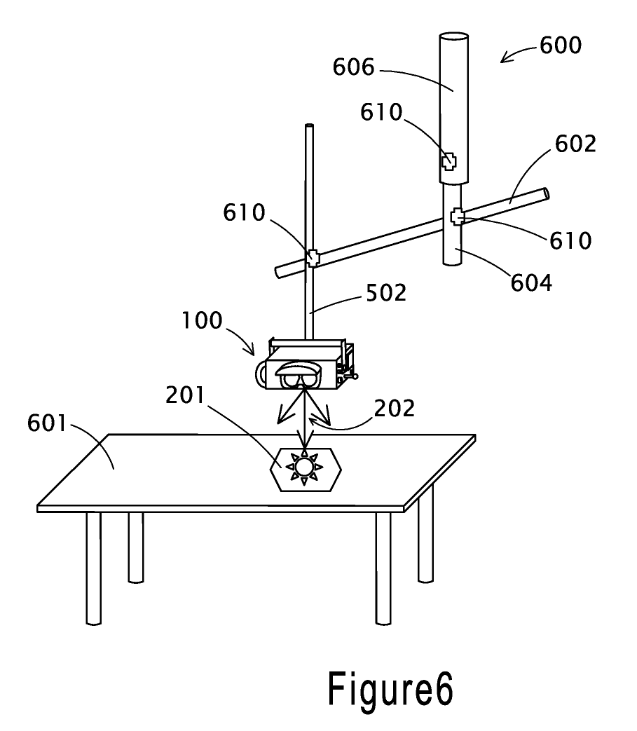

The vertical support member 502 of the 3D stereo viewer 100, represented in FIG. 5, can be mounted on and/or coupled to a support structure 600 comprising one or more adjustable support members 602, 604, and 606 as illustrated in FIG. 6. The support members 602, 604, and 606 can be movably coupled together to support and allow repositioning of the 3D stereo viewer 100. For example, a first support member 606 may be oriented along a substantially vertical axis and mounted or anchored to the ceiling of the operating room or on a separate mechanical overhead structure such as the operating room lights. A second support member 604 may be oriented along a substantially vertical axis and may be coupled to and operatively associated with the first support member 606. In one embodiment, the second support member 604 may be configured to telescope out of the first support member 606 in an axial direction to allow a user to adjust the height of the supported 3D stereo viewer 100. In a further embodiment, the second support member 604 may be concentrically rotatable relative to the first support member 606, thereby allowing a user to adjust the rotatable position of the 3D stereo viewer 100 relative to the first support member 606.

A third support member 602 may be oriented along a substantially horizontal axis and may be coupled at or proximate one end to the second support member 604 and coupled at or proximate the opposite end to the vertical support member 502. The third support member 602 may be configured to be angularly rotatable with respect to the longitudinal axis of the first support member 606, the second support member 604, and/or the vertical support member 502, thereby allowing a user several degrees of freedom to adjust the position of the 3D stereo viewer 100. As a result, a user can maneuver the 3D stereo viewer 100 to a desired position over the operating table 601 and work area 201. Rotational and axial positioning of the 3D stereo viewer 100 may be facilitated by rotational and sliding hinges 610, which may couple one or more support members together. The sliding hinges 610 may also be equipped with locking mechanisms and may be manipulated manually or automatically.

Various other electromechanical mounting mechanisms can be implemented as multi-jointed holding system for the 3D stereo viewer 100, where the user can manually or robotically position the 3D stereo viewer 100 to the desired location. In a further embodiment, the positioning of the 3D stereo viewer 100 can be accomplished by using a separate remote control mechanism. Support member 602, 604, and 606 and/or vertical support member 502 can house such robotic manipulation actuators for automatically positioning the 3D stereo viewer 100 at the desired position. Positional information can be stored in a remote control mechanism along with the user's information, so the same position can be set and retrieved and implemented automatically in subsequent procedures.

Using various 3D stereo endoscopes and stereo microscopes in endoscopic procedures or endoscopic and open surgical procedures, allows enlarged view of the surgical site to be readily available to the surgeon and other medical staff in stereo, and in an ergonomic fashion. Multiple viewers can be configured for the staff in the same surgical room to have similar or various 3D stereo view for coordinated functions or as a learning tool.

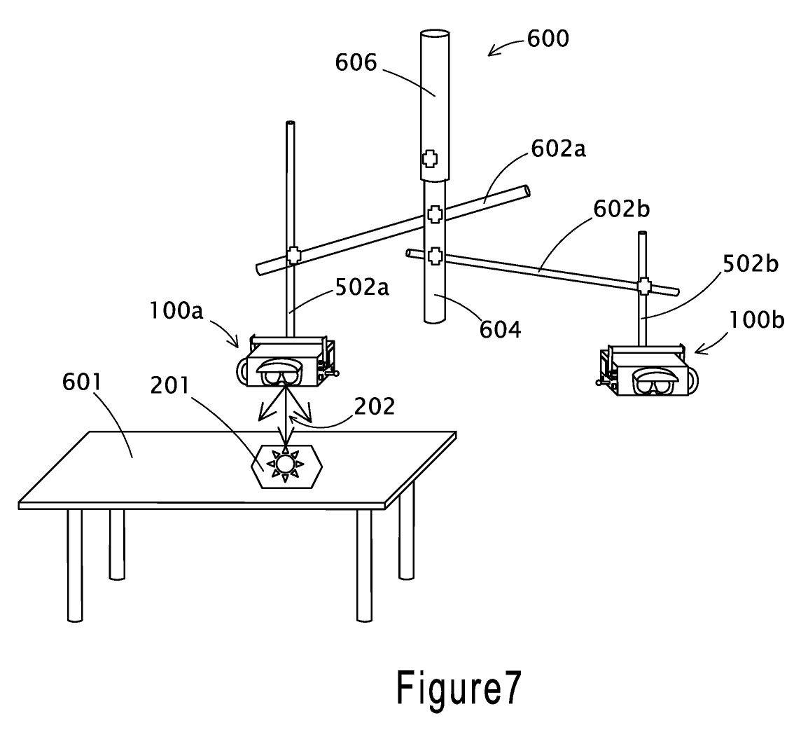

FIG. 7 represents a further embodiment accommodating a first 3D stereo viewer 100a and a second 3D stereo viewer 100b coupled to the same vertical support member 604 and 606 with dual horizontal support member 602a and 602b and dual vertical support members 502a and 502b. In a further embodiment, the multiple horizontal support member 602a and 602b can further comprise a single round or elliptical structure or railing that is horizontally mounted over and around the operating table, where multiple 3D stereo viewers 100 and their vertical support members 502, can be hanging from the horizontal railing like a curtain.

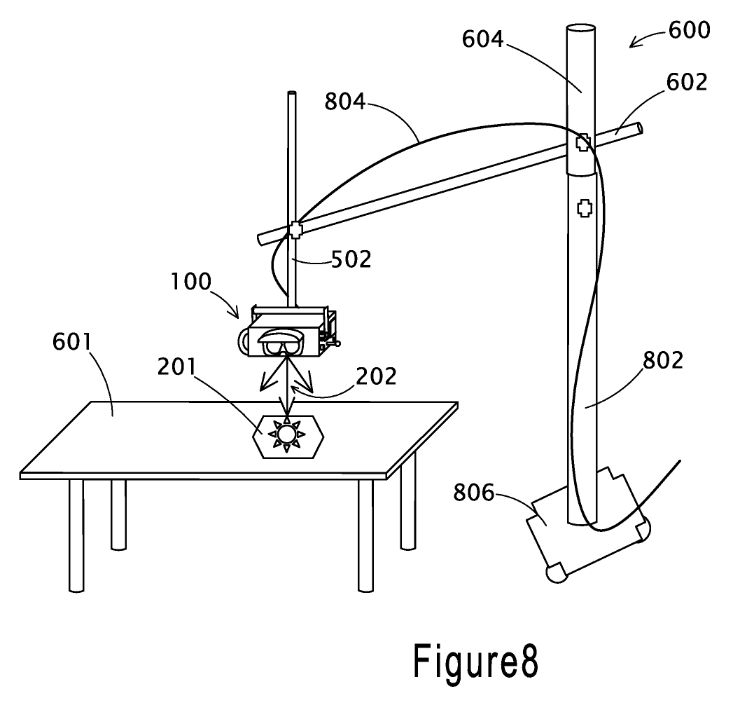

FIG. 8, illustrates the 3D stereo viewer 100 with one or more support members 502, 602, and 604 being mounted on a floor post 802, that is portably situated on a movable, such as rollable, base structure 806 similar to an IV post used in hospitals, that can be locked in position once in proper position. FIG. 8 also discloses electrical or optical connections, such as wires or optical fiber cable connections, to the 3D stereo viewer 100 that run along or inside the one or more portions of the support structure.

The 3D stereo viewer 100 can be also equipped with various mechanisms of one or two way communication for receiving imaging data and executing user commands. Other than direct electronic connection, the 3D stereo viewer 100 can take advantage of high bandwidth fiberoptic multimedia connections or wireless communication with high bandwidth, send-and-receive capability. Any physical connection to the 3D stereo viewer 100 including a power connection can be made via the support structure as described in FIG. 8. In a further embodiment, the 3D stereo viewer 100 can be equipped with a rechargeable battery source, which can be connected to the charging cable when the unit is not in use.

An electronic storage mechanism can also be incorporated in the 3D stereo viewer 100, such as in the viewer body 102, for local storage of information or transfer of information to and from the display unit. Certain user or patient data and information, can be locally stored or communicated to the 3D stereo viewer 100. Such information could be used as record keeping or training, as well as user data such as positional information for the display unit, and adjustment levels of the stereo display for specific user.

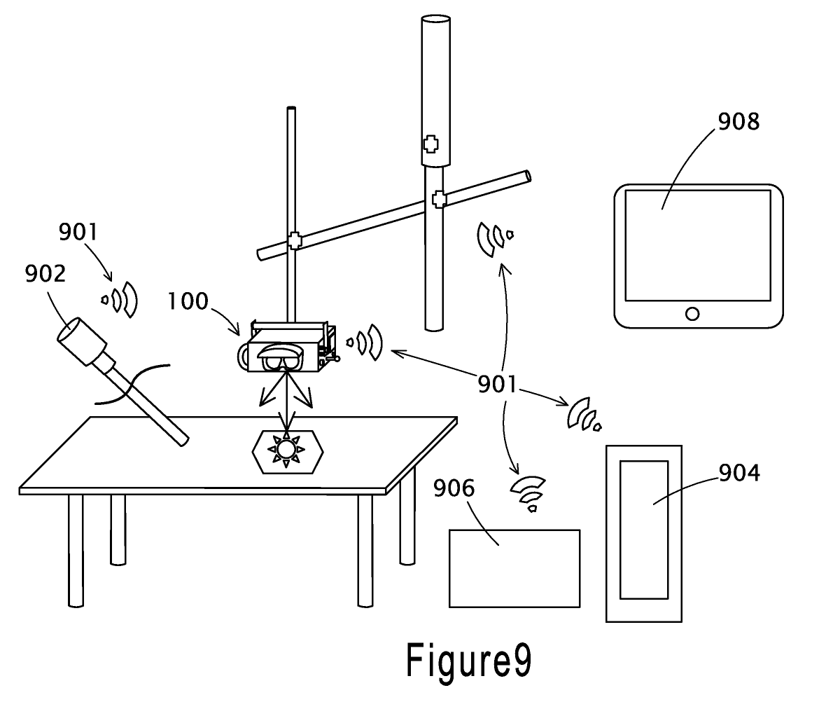

The 3D stereo viewer 100 can be part of a larger connectivity member in the operating room, the hospital, or a larger networked environment, where imaging, video, and voice data can be communicated to and from different equipment via full multi-media connectivity solution. FIG. 9 discloses one wireless connectivity embodiment connecting a stereo endoscope 902 transmitting video data through a wireless connection 901 to the local 3D stereo viewer 100, as well as possibly to a remote computer 904, and a wireless networked storage device 906, and possibly to a wireless equipped large monitor display 908 or individual remote 3D stereo viewers, similar to the 3D stereo viewer 100, placed in classrooms or observation rooms.

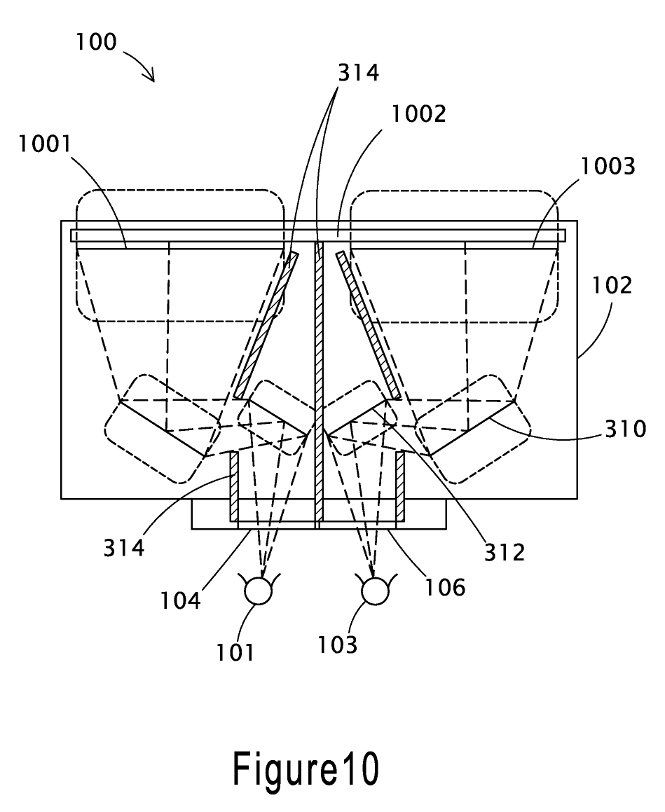

As the flat panel display resolution and size improves, it is possible to use a single display to display left and right stereo images at the same time. This can equate to cost and space savings in the 3D stereo viewer 100. FIG. 10 discloses one embodiment of an optical design, where a single display 1002 is used to display left and right images 1001 and 1003 side by side on the same display 1002.

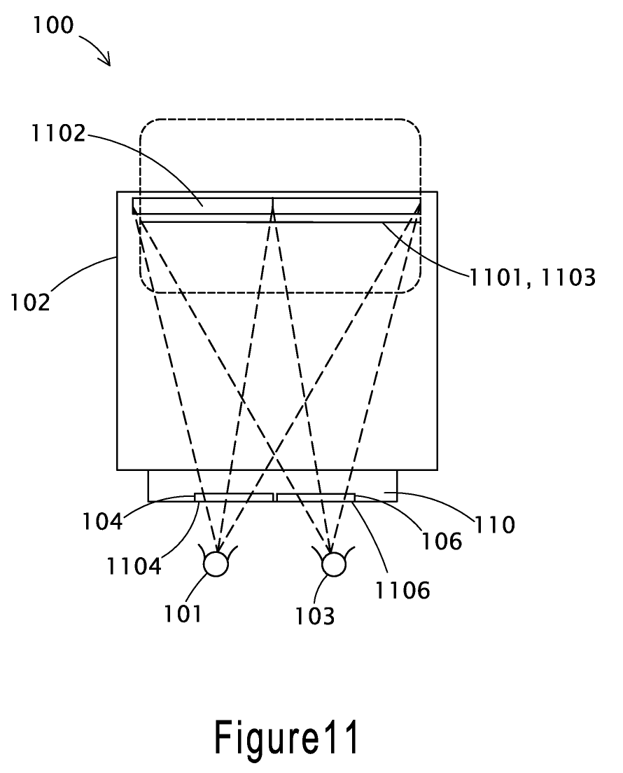

FIG. 11 represents an additional embodiment of a 3D stereo viewer 100 using a single display, where the display 1102 alternates between right and left images 1101 and 1103 at a high rate not noticeable by the viewer. To visualize the left and right images 1101 and 1103 in stereo, the left and right visual access ports 104 and 106 of the 3D stereo viewer 100 can be equipped with time synchronized LCD shutters 1104 and 1106 that alternate between the open and shut states. As the left LCD shutter 1104 is open in time, display 1102 can be made to display the left image 1101 at the same time, and as the right LCD shutter 1106 is open in time, display 1102 can be made to display the right image 1103 at the same time. The image mixing as well as time synchronization electronics, and control mechanism can be utilized within the viewer body 102 linking the display 1102 to the LCD shutters 1104 and 1106.

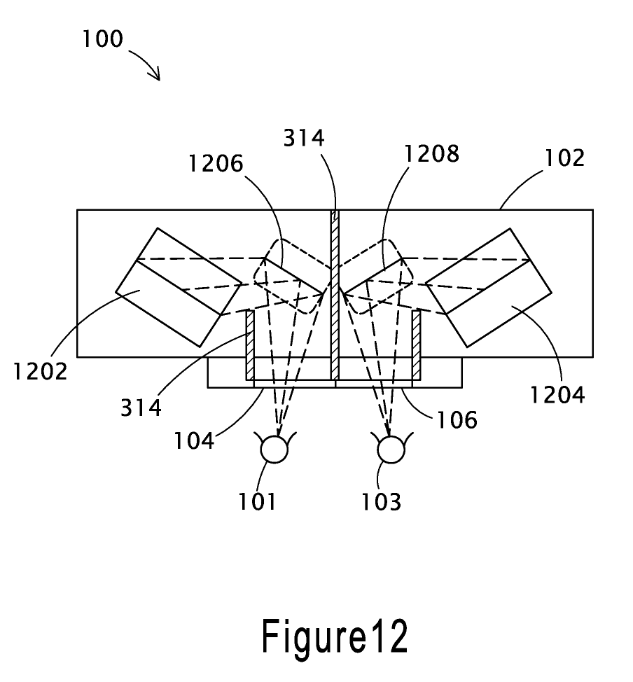

In another embodiment, especially where the display is preferred to be tilted up in front of the user, it may be desirable to have a 3D stereo display with shorter depth along the line of sight into the display. One implementation of this embodiment is represented in FIG. 12, where the displays 1202 and 1204 are positioned above the plane of the visual ports 104 and 106 for the user left and right eyes 101 and 103. In this embodiment, fold mirrors 1206 and 1208 can be used to fold the optical path downward from the displays 1202 and 1204 to the user's eyes 101 and 103, through the visual ports 104 and 106. To view the right and left images properly after the single fold mirrors 1206 and 1208 in the right and left eye optical path, the displayed images can be flipped and mirrored electronically as appropriate on the displays 1202 and 1204 respectively.

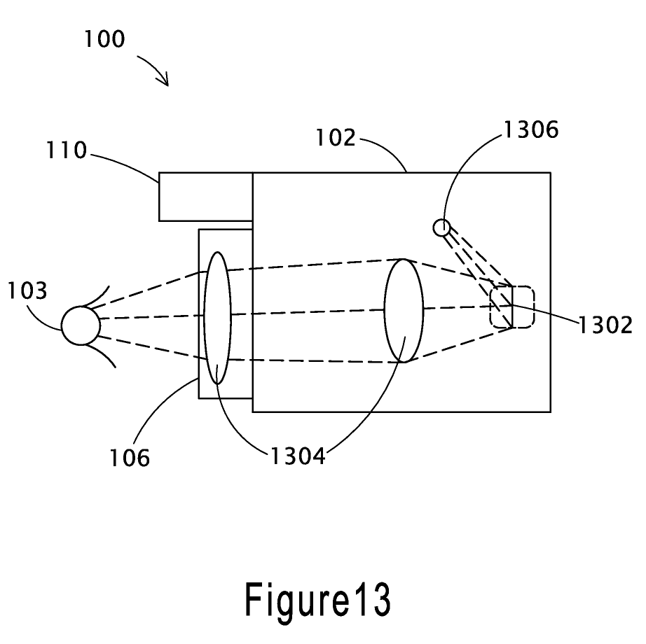

In a further embodiment of the current disclosure, 3D stereo viewer 100 may include dual micro displays using projection optics that can project left and right eye images to screen positions used instead of or in addition to the flat panel's displays. FIG. 13 discloses a schematic of a 3D stereo viewer 100 for the right eye 103, where the visual access port 106 houses part of the projection optics 1304. A reflective type micro display unit 1302 can be illuminated by the illuminator 1306 and the projected image can be viewed by the user through the visual access port 106. In one embodiment, the illuminator 1306 of the micro display unit 1302 may make use of RGB LED light sources that are frame synchronized with the micro-mirror display unit 1302, displaying RGB image frames at high frequency. Alternatively reflective or transmissive color LCD micro-displays can be incorporated into the 3D stereo viewer 100.

What is claimed is:

1. A device for individual viewing of a 3D stereo image by a user without attachment to the user's body and configured to offer an extended distance for positioning of the user's eyes with respect to the stereo image, the device comprising:
a body having one or more visual access ports;
one or more displays configured to display stereo images, the one or more displays being chosen from a group consisting of single panel displays, dual panel displays, and micro displays; and
one or more fold mirrors or projection optics configured to direct, transmit, or project the stereo images to the one or more visual access ports.

2. The device of claim 1, wherein the one or more visual access ports include optical elements having optical power.

3. The device of claim 2, wherein the optical elements include a coating or device configured to provide light polarization.

4. The device of claim 2, where in the optical elements comprise electronically controlled optical shutters.

5. The device of claim 3, where in the optical shutters are time synchronized with the one or more displays.

6. The device of claim 2, wherein the optical elements are different for each eye.

7. The device of claim 2, wherein the optical elements are removable and exchangeable.

8. The device of claim 1, wherein the one or more displays are positioned within the body.

9. The device of claim 1, wherein the one or more displays are positioned relative to each other with optical mechanisms of transmission or projection.

10. The device of claim 1, further comprising a display convergence distance from the user's eye similar to the distance from the user's eye if performing direct surgery.

11. The device of claim 1, further comprising a light-absorbing optical baffle mechanism.

12. The device of claim 1, further comprising one or more surface relief or user support structures proximate the visual access ports configured to accommodate, receive, or support the nose or forehead of a user.

13. The device of claim 12, further comprising a soft disposable padding configured to wick the sweat off the forehead of the user.

14. The device of claim 1, further comprising a source of illumination coupled to the body.

15. The device of claim 1, being further configured to produce a viewable image through the one or more visual access ports a distance away from the body, thereby creating a free space for the user to easily gain visual access to the area below the device.

16. A system configured for individual viewing 2D or 3D mono or stereo image information, the system comprising:
a viewer comprising:
a body having one or more visual access ports;
one or more displays configured to display stereo images, the one or more displays being chosen from a group consisting of single panel displays, dual panel displays, and micro displays; and
one or more fold mirrors or projection optics configured to direct, transmit, or project the stereo images to the one or more visual access ports;
a fully maneuverable and lockable support structure configured to support the viewer and allow the viewer to move in a plurality of directions in front of the user's eyes, the support mechanism comprising a plurality of support members.

17. The system of claim 16, the support structure allows the tilt angle of the viewer to be adjustable for the user's preferred direction of view.

18. The system of claim 16, wherein the support mechanism is coupled to a fixed structure or a movable base structure.

19. The system of claim 16, wherein the support structure includes one or more straight, round or elliptical support members where one or more of viewers can be adjustably mounted thereon.

20. The system of claim 16, further comprising a mechanical or electromechanical manipulation mechanism to control, actuate, and maneuver the device in space, the mechanical or electromechanical manipulation mechanism being configured for manual manipulation, automatic manipulation, or robotic manipulation by a separate remote control mechanism.

21. The system of claim 16, further comprising electrical power or electrical or fiber optic communication cables are routed around or through the support structure.

22. A system for individual viewing of 2D or 3D mono or stereo image information, the system comprising:
a support structure comprising one or more support members;
compact viewer for individual viewing of 2D or 3D mono or stereo image information maneuverably coupled to the support structure; and
a two-way communication mechanism.

23. The system of claim 22, further comprising a microprocessor.

24. The system of claim 23, wherein the microprocessor is configured to process images, control single or multiple image display timing, set image positioning and orientation, and synchronize image display with opto-electronic units within or outside the viewer.

25. The system of claim 22, wherein the viewer further comprises a fixed or removable data storage device.

26. The system of claim 22, wherein the viewer further comprises a user interface device chose from the group consisting of a touch pad, finger mouse, joystick, and electromechanical input devices.

27. The system of claim 22, further comprising a voice recognition device.

28. The system of claim 22, wherein the viewer further comprises a battery unit which can be removed, exchanged, or recharged.

29. The system of claim 22, wherein the two-way communication mechanism comprises one or more electrical wires.

30. The system of claim 22, wherein the two-way communication mechanism comprises a fiber optic cable and an optical transceiver.

31. The system of claim 22, wherein the two-way communication mechanism is housed inside the viewer.

32. The system of claim 22, further comprising a connection to mono or stereo endoscope and wherein the viewer displays real time information from the endoscope.

33. The system of claim 32, wherein the viewer is configured to send commands from the user or automatically send commands from it's microprocessor to the endoscope to change the illumination, change the image detection conditions, control the optical zoom, control the optical focus, or change position of the endoscope.

34. The system of claim 22, further comprising a connection to a mono or stereo microscope and wherein the viewer displays real time information from the microscope.

35. The system of claim 33, wherein the viewer is configured to send commands from the user or automatically send commands from its microprocessor to the microscope to change the illumination, change the image detection conditions, control the optical zoom, control the optical focus, or change position of the object under the microscope.

36. The system of claim 22, wherein the viewer is configured to display information from a network storage device and send imaging information to the storage network device.

37. The system of claim 22, wherein the device displays computer generated 2D or 3D information side by side with or as an overlay to other live video information.
